(19) United States
(12) Patent Application Publication
(10) Pub. No.: US 2020/0021443 A1
(43) Pub. Date: Jan. 16, 2020

(54) METHOD AND TIMER FOR PROVIDING SECURITY-PROTECTED TIME INFORMATION

(71) Applicant: Siemens Aktiengesellschaft, DE (DE)

(72) Inventor: RAINER FALK, POING (DE)

(21) Appl. No.: 16/495,220

(22) PCT Filed: Sep. 26, 2017
(86) PCT No.: PCT/EP2017/074322

§ 371 Date: Sep. 18, 2019

(30) Foreign Application Priority Data
Mar. 31, 2017 (EP) 17164202.8

(51) Int. Cl. H04L 9/32; H04L 9/06; G06F 21/64

(52) U.S. Cl. CPC H04L 9/3239; H04L 9/0643; G06F 21/64; G06Q 2220/00; H04L 2209/38; H04L 2209/56; H04L 9/3247

(57) ABSTRACT

Provided is a method for the computer-assisted provision of security-protected time information, including the method steps: acquiring first time information from one or more time sources. Storing transactions, wherein the transactions comprise the first time information and or first check sums for the first time information are calculated and the transactions include the first check sums. Creating the security-protected time information by generating elements of a block chain, wherein the elements each comprise at least one of the transactions and the elements are linked with one another to form the block chain.

### CROSS-REFERENCE TO RELATED APPLICATIONS

This application claims priority to PCT Application No. PCT/EP2017/074322, having a filing date of Sep. 26, 2017, which is based on European Application No. 17164202.8, having a filing date of Mar. 31, 2017, the entire contents both of which are hereby incorporated by reference.

### FIELD OF TECHNOLOGY

The following relates to a method and to a timer for the computer-assisted provision of security-protected time information.

### BACKGROUND

Blockchain or “distributed ledger” technology is a technology that is being greatly discussed at present. In addition to applications for decentralized payment systems (for example Bitcoin), new application possibilities are being developed in the financial industry. Transactions between firms are thereby in particular able to be performed in a manner protected against manipulation without intermediaries or clearing houses. This allows new business models without a trusted intermediary, it reduces transaction costs, and flexible new digital services are able to be offered without having to set up an infrastructure and trusted relationships that are set up specifically for this purpose. A transaction dataset (or transaction for short) protected by a blockchain comprises for example program code, which may also be referred to as what is known as a “smart contract”.

### SUMMARY

An aspect relates to a method and a timer for the computer-assisted provision of security-protected time information.

According to a first aspect, embodiments of the invention relate to a method for the computer-assisted provision of security-protected time information, having the following method steps:
recording (110) first time information from one or more time sources;
storing (120) transactions, wherein
   the transactions comprise the first time information and/or
   first checksums for the first time information are calculated and the transactions comprise the first checksums;
creating (130) the security-protected time information by generating blocks of a blockchain or of a distributed database, wherein
   the blocks each comprise at least one of the transactions,
   the blocks are chained to one another to form the blockchain or to form the distributed database,
   in particular a first duration is determined that indicates the delay with which the security-protected time information is inserted into the blockchain or into the distributed database, wherein at least some of the transactions or additional transactions each comprise the first duration as fifth additional information,
in particular transmitting the blocks (including the security-protected time information) to at least one computer/receiver.

Unless indicated otherwise in the following description, the terms “perform”, “calculate”, “computer-assisted”, “compute”, “establish”, “generate”, “configure”, “reconstruct” and the like may relate to actions and/or processes and/or processing steps that change and/or generate data and/or that convert data into other data, wherein the data may be represented or be present in particular in the form of physical variables, for example in the form of electrical pulses. The expression “computer” should in particular be understood in the broadest possible sense, so as in particular to cover all electronic devices having data processing properties. Computers may thus be for example personal computers, servers, programmable logic controllers (PLCs), hand-held computer systems, pocket PC devices, mobile radio devices and other communication devices that are able to process data in a computer-assisted manner, processors and other electronic data processing devices.

“Computer-assisted” in the context of embodiments of the invention may be understood to mean for example an implementation of the method in which in particular a processor executes at least one method step of the method.

A processor in the context of embodiments of the invention may be understood to mean for example a machine or an electronic circuit. A processor may in particular be a main processor or central processing unit (CPU), a microprocessor or a microcontroller, for example an application-specific integrated circuit or a digital signal processor, possibly in combination with a memory unit for storing program commands, etc. A processor may also be for example an IC (integrated circuit), in particular an FPGA (field-programmable gate array) or an ASIC (application-specific integrated circuit) or a DSP (digital signal processor) or a graphic processing unit GPU. A processor may also be understood to mean a virtualized processor, a virtual machine or a soft CPU. This may also be for example a programmable processor that is equipped with configuration steps for executing the method according to embodiments of the invention or is configured with configuration steps such that the programmable processor implements the features according to embodiments of the invention of the method, the component, the modules, or other aspects and/or partial aspects of embodiments of the invention.

A “memory unit” or “memory module” and the like in the context of embodiments of the invention may be understood to mean for example a volatile memory in the form of working memory (random access memory, RAM) or a permanent memory such as a hard disk or a data carrier.

A “module” in the context of embodiments of the invention may be understood to mean for example a processor and/or a memory unit for storing program commands. By way of example, the processor is specifically configured so as to execute the program commands such that the processor thereby executes functions in order to implement or perform the method according to embodiments of the invention or a step of the method according to embodiments of the invention.

“Providing” or “provision” in the context of embodiments of the invention may be understood to mean for example loading or storing for example the first time information and/or the security-protected time information on or from a memory module. “Providing” or “provision” may also be understood to mean for example transmitting (or sending or transferring) the security-protected time information to a computer that is designed as a receiver (for example device for synchronizing a clock of a computer).

A “checksum”, for example the first checksum, a node checksum, a transaction checksum, a chaining checksum or the like, in the context of embodiments of the invention may be understood to mean for example a cryptographic checksum or cryptographic hash or hash value that is formed or calculated in particular by way of a cryptographic hash function using a dataset and/or data and/or one of the transactions and/or a block header. A checksum may in particular be a checksum or checksums or hash value or hash values of a hash tree (for example Merkle tree, Patricia tree). It may furthermore also be understood to mean in particular a digital signature or a cryptographic message authentication code.

A “first checksum” in the context of embodiments of the invention may be understood to mean a checksum that is calculated for example using the data(sets) of a transaction. Instead of the data, for example the selected portion of the data, a transaction may comprise for example only the checksum more precisely the corresponding associated first checksum for these data. The corresponding data may then be provided for example in a further transaction of a further block. It is however also conceivable for example for these data to be provided via another communication channel. A node may then for example check the integrity/authenticity of the data by way of the first checksum from the blockchain. In addition to the first checksum, an additional dataset may also be stored for example in the transactions, which in particular indicates a memory location from where the data are able to be retrieved. This is advantageous in particular for keeping a data size of the blockchain as small as possible. In addition, a calculation of a transaction checksum is able for example to be sped up, since checksums are already present here and these are able to be used in the same way as leaves for example of a Merkle tree. In this case, forming a separate checksum using the additional dataset is in particular able to be dispensed with.

“Transaction checksum” in the context of embodiments of the invention may be understood to mean a checksum that is formed in particular by the respective transactions of one of the respective blocks and/or preceding block/block preceding a block of the blockchain. In addition or as an alternative, the transaction checksum may in particular also have been formed by transactions of a preceding block/block preceding the block. The transaction checksum may in this case also be formed in particular by way of a hash tree, for example a Merkle tree [1] or a Patricia tree, wherein the transaction checksum is in particular the root checksum of the Merkle tree or of a Patricia tree or of a binary hash tree. Transactions are in particular secured by way of further checksums from the Merkle tree or Patricia tree, wherein the further checksums are in particular leaves in the Merkle tree or Patricia tree. The transaction checksum is thus able for example to secure the transactions by forming the root checksum from the further checksums. The transaction checksum may in particular be calculated for transactions of a first block of the blocks. Such a transaction checksum may in particular be incorporated into a block following the first block so as to chain this following block for example to its preceding blocks (for example the first block) and in particular thereby make an integrity of the blockchain able to be checked.

A “chaining checksum” in the context of embodiments of the invention may be understood to mean a checksum that indicates or references the preceding block of the blockchain, in particular for a respective block of the blockchain (in particular often referred to as “previous block hash” in the jargon) [1]. The transaction checksum of a block may be used for example as chaining checksum in order to chain a new block to a block of the blockchain. It is however also possible for example for a checksum to be formed by a header of the preceding block or by the entire preceding block and to be used as chaining checksum. A respective block of the blockchain may in each case comprises a chaining checksum that has been calculated for a block preceding the respective block.

A “distributed database” in the context of embodiments of the invention may be understood to mean for example a database distributed in a decentralized manner, a blockchain or a peer-to-peer database. If for example a blockchain is used, then this may be implemented in particular by way of a Bitcoin-based implementation or an Ethereum-based implementation. A “distributed database” in the context of embodiments of the invention may also be understood to mean for example distributed databases or databases distributed in a decentralized manner, without a distributed database in the form of a blockchain. It should in particular be understood here that in this case, by way of this disclaimer, the blockchain is for example possibly not contained in possible specific implementation variants of distributed databases. Otherwise, the exemplary embodiments and embodiments that are directed to a blockchain are in particular likewise able to be transferred to a distributed database.

“Security-protected” in the context of embodiments of the invention may be understood to mean for example protection that is provided in particular by way of a cryptographic method. By way of example, this may be achieved using the blockchain to provide or transmit or send the time information. This may be achieved by combining the various (cryptographic) checksums, since these interact in particular synergistically in order for example to improve the security or the cryptographic security of satellite navigation datasets. In other words, “security-protected” in the context of embodiments of the invention may also be understood to mean in particular “cryptographically protected” or “protected against manipulation”.

“Chaining (the) blocks of a blockchain” in the context of embodiments of the invention may be understood to mean for example that blocks each comprise information (for example chaining checksum) that indicate or reference another block or a plurality of other blocks of the blockchain [1].

“Insertion into the blockchain” and the like in the context of embodiments of the invention may be understood to mean for example that in particular a transaction or the transactions or a block containing its transactions are transmitted to one or more nodes of a blockchain. If these transactions are validated successfully for example (for example by the node/nodes), these transactions are in particular chained as a new block/blocks to at least one existing block of the blockchain [1]. This validation and/or chaining may in particular be performed by a trusted node (for example a mining node or a blockchain platform). In this case, a blockchain platform may in particular be understood to mean a blockchain as a service, as is proposed in particular by Microsoft or IBM. A trusted node and/or a node may in particular in each case store a node checksum (for example a digital signature) in a block in order in particular to allow the creator of the block to be identifiable and/or to allow the node to be identifiable. In this case, this node checksum indicates which node for example has chained the corresponding block to at least one other block of the blockchain.

“Transaction” or “transactions” in the context of embodiments of the invention may be understood to mean for example a smart contract, a data structure or a transaction dataset that in particular in each case comprises one of the transactions or a plurality of transactions. “Transaction” or “transactions” in the context of embodiments of the invention may also be understood to mean for example the data of a transaction of a block of a blockchain. A transaction dataset or a transaction may comprise a program code that in particular creates a smart contract. A “transaction dataset” in the context of embodiments of the invention may also be understood to mean for example a transaction of a block of a blockchain. By way of example, in the context of embodiments of the invention, a transaction may also be understood to mean a real-time confirmation transaction and/or a time synchronization transaction (TimeSync transaction).

A “program code” in the context of embodiments of the invention may be understood to mean for example control commands, program commands or control instructions that are stored in particular in a transaction.

A “smart contract” in the context of embodiments of the invention may be understood to mean for example an executable program code. The program code is in particular able to be executed on a virtual machine.

“Storing transactions” in the context of embodiments of the invention may be understood to mean for example storing data (for example time information, additional information, etc.) in a transaction or in a transaction dataset. It is also conceivable for example for the data not to be stored directly, but rather for just a checksum (for example the first checksum) of the corresponding data to be stored in the transaction.

“Proof of work” in the context of embodiments of the invention may be understood to mean for example solving a computationally intensive task that needs to be solved in particular depending on block content/content of a first transaction dataset [1]. Such a computationally intensive task is also referred to for example as a cryptographic puzzle.

“Block” in the context of embodiments of the invention may be understood to mean for example a block of a blockchain that is formed in particular as a data structure and may in each case comprises one of the transactions or a plurality of the transactions. A block may comprise for example information about the size (data size in bytes) of the block, a block header, a transaction counter and one or more transactions [1]. The block header may for example comprise a version, a chaining checksum, a transaction checksum, a timestamp, a proof of work and a nonce (single value, random value or counter for the proof of work is used) [1]. “Nonce” in the context of embodiments of the invention may be understood to mean for example a cryptographic nonce (abbreviation for: “used only once”[2] or “number used once”[3]). A nonce in particular denotes individual numbers or a combination of letters that may be used just once in the respective context (for example transaction, data transmission).

“Blocks preceding a (first) block of the blockchain” in the context of embodiments of the invention may be understood to mean for example only the block of the blockchain that in particular directly precedes a (first) block. As an alternative, “blocks preceding a (first) block of the blockchain” may also in particular be understood to mean all of the blocks of the blockchain that precede the first block. As a result, the chaining checksum or the transaction checksum may for example in particular be formed only by the block directly preceding the first block (or its transactions) or by all blocks preceding the first block (or their transactions).

A “blockchain node”, “node”, “node of a blockchain” and the like in the context of embodiments of the invention may be understood to mean for example devices (for example field devices), computers, smartphones, clients or participants that perform operations involving a blockchain [1]. Such nodes may for example execute transactions of a blockchain or its blocks or insert or chain new blocks containing new transactions into the blockchain by way of new blocks. This validation and/or chaining may in particular be performed by a trusted node (for example a mining node) or exclusively by trusted nodes. A trusted node is for example a node that has additional security measures (for example firewalls, access restrictions to the node or the like) in order to prevent manipulation of the node. As an alternative or in addition, a trusted node may for example store a second checksum (for example a digital signature or a certificate) in a new block when the new block is chained to the blockchain. As a result, it is in particular possible to provide proof that indicates that the block was inserted by a particular node or indicates its origin.

A “computer” in the context of embodiments of the invention may be understood to mean for example a computer (system), a client, a smartphone, a device or a server that are in each case arranged outside the blockchain or are not a participant of the blockchain (that is to say do not perform any operations involving the blockchain or only query these without however performing transactions, inserting blocks or calculating proof of work). As an alternative, a computer may also in particular be understood to mean a node of a blockchain.

“Time information” in the context of embodiments of the invention may be understood to mean for example a timestamp, time synchronization information, a (current) time or any other type of time information. The time information is in particular the data that a respective transaction comprises.

“Additional transaction” in the context of embodiments of the invention may be understood to mean for example transactions that comprise in particular additional information, but may not comprise any time information. These additional transactions may for example be inserted into the blockchain by way of a new block (for example, the new block comprises the additional transaction) and, in the event of a successful validation (also for example called confirmation) of the additional transaction, the new block may be chained to the blockchain.

“Additional information” in the context of embodiments of the invention may be understood to mean for example information that is stored together with the time information, for example in a transaction of a corresponding block. As an alternative, the additional information may be stored for example in a further transaction of the corresponding block. In a further alternative, the additional information may be inserted for example into the blockchain by way of an additional transaction.

The method is advantageous in particular for providing trusted time information by way of a decentralized blockchain infrastructure. The embodiments make it possible for example to use a decentralized blockchain in order to provide reliable time information/time information protected against manipulation. This may, for example, be used equally within the blockchain by smart contracts and outside the blockchain by computers or clients. In particular, the first time information may be provided by the one or more time sources, which may also referred to as (primary) timers. In particular, the first duration is determined by a blockchain node/computer that has for example a real-time clock.

In a first embodiment of the method, the blocks are chained to one another by a cryptographic hash function.

In a further embodiment of the method, the one or more time sources is/are a GPS time source and/or a Galileo time source and/or Glonass time source and/or Beidou time source and/or DCF77 time source and/or atomic clock time source and at least some of the transactions or additional transactions may comprise first additional information about the time source.

The method is advantageous in particular for providing time information that is as accurate as possible by way of the plurality of time sources (also called clocks).

In a further embodiment of the method, at least some of the transactions or additional transactions each comprise second additional information that indicates a type of the time source.

The method is advantageous in particular for providing the information about the technical implementation or the type of time source/sources used (for example temperature-compensated quartz oscillator, chip-scale atomic clock CSAC, regular atomic clock, the type of an atomic clock, for example rubidium clock, iridium clock, cesium clock or hydrogen maser clock), accuracy information (for example absolute, for example +/−1 second, drift accuracy, for example 0.01 s/24 h).

In a further embodiment of the method, at least some of the transactions or additional transactions each comprise third additional information that indicates an accuracy of the security-protected time information.

The method is advantageous in particular for providing information, in a security-protected manner, about the precision of the respective time information.

In a further embodiment of the method, at least some of the transactions or additional transactions each comprise fourth additional information that indicates a time system of the security-protected time information.

The method is advantageous in particular for providing information, in a security-protected manner, about which time system (for example UTC, GPS System Time, Galileo System Time) is used.

In a further embodiment of the method, a first duration is determined that indicates the delay with which the security-protected time information is inserted into the blockchain, wherein at least some of the transactions or additional transactions each comprise the first duration as fifth additional information.

The method is advantageous in particular for providing information, in a security-protected manner, about how long it takes until time information is chained to the blockchain. For this purpose, a timer (for example a primary timer) checks the delay with which a block is inserted into the blockchain. This may be achieved for example by way of a specific transaction, for example a real-time assertion transaction. Such a real-time assertion transaction may in particular contain time information that specifies for example how long it takes until the transaction is validated successfully and is inserted into the blockchain by way of a block. Depending on the determined delay, the fifth additional information is provided (for example average value/expected value of the delay, variance of the delay).

In a further embodiment of the method, the transactions of at least some of the blocks comprise at least the first time information and the first duration. In other words, at least some of the blocks (not all of the blocks) comprise at least the first time information and the first duration in their transactions.

The method is advantageous in particular for taking into consideration a time delay with respect to a calibrated reference timer (for example a real-time clock) when using the first time information. For this purpose, the first duration is in particular used, this having been determined for example by a blockchain node with a reference timer. For this purpose, the blockchain node for example determines the time delay (first duration) with which for example a transaction (for example the transaction that comprises the first time information) is inserted in a (particular/selected) block of the blocks of the blockchain, for example until the corresponding transaction (comprises for example an identifier that may be unique) is available as validated transaction in the (particular/selected) block of the blockchain. In practice, the particular/selected block is defined for example in that it comprises the corresponding transaction (for example able to be identified by a unique value in the transaction). For example, the time that has elapsed since the corresponding transaction was created until being available in the (particular/selected) block as validated transaction is then measured. As an alternative or in addition, the time difference/temporal difference between the first time information and the time at which the corresponding transaction (which may be the transaction containing the first time information) was made available as validated transaction by the (particular/selected) block may also be taken into account in the first duration. By way of example, this first duration is inserted into a transaction in a following block, the directly following block (for example as validated transaction). This transaction (containing the first duration) of a corresponding block may then be used in various ways. By way of example, for insertion into the block (in particular also called particular/selected block) for which the first duration was calculated, the time delay (with respect to a reference timer) for the first time information may be determined or an inaccuracy (with respect to a reference timer) for the first time information may be determined. As an alternative or in addition, the following blocks (following the particular/selected block), at least the directly following block (for example calculated for the first duration, which indicates how long it takes until a transaction is available in a block as validated transaction that is to say the block that directly follows the particular/selected block in the blockchain), comprise(s) the first duration. As a result, it is possible for example also to determine the time delay for the first time information or determine an inaccuracy for the first time information, wherein for this purpose in particular a deviation/tolerance range may be taken into consideration, since the first duration relates to insertion of a transaction into another block. A computer may use the first time information (from the time synchronization transaction) and the first duration (from the real-time confirmation transaction) of a particular block to set its (local) clock with very high accuracy. This high accuracy is set in particular with respect to the reference timer that determined the first duration or inserted the corresponding transaction into the blockchain. In particular, at least some of the blocks comprise at least one transaction containing a first duration, all of the blocks comprise at least one transaction containing a first duration. Even more, the first block may not comprise any first duration and only the following blocks comprise a first duration, beginning with the blocks directly following the first block. The first duration may also be determined for example in another way, as is explained for example in the exemplary embodiments. The first duration may in particular be an average value/expected value of the delay, variance of the delay. The first duration may in particular be determined for one or more blocks of the blockchain, such that this first duration is inserted for example only into these corresponding blocks of the blockchain. The one or more blocks may be predefined for example by a time pattern or a time interval.

In a further embodiment of the method, if a particular block of the blockchain or of the distributed database comprises a transaction containing first time information and the particular block does not comprise any transaction containing the first duration, a corresponding first duration for the particular block is interpolated and/or approximated from one or more blocks preceding the particular block and/or one or more blocks following the particular block.

The method is advantageous in particular for estimating/interpolating/approximating a first duration for blocks of the blockchain that do not comprise any transaction containing a first duration. A computer is in particular able to use the first time information (from the time synchronization transaction) of the particular block and the (estimated) first duration to set its (local) clock with very high accuracy. This high accuracy is in particular set with respect to a reference timer that determined for example the first durations of the preceding and following blocks or inserted the transactions therefor into the blockchain.

In a further embodiment of the method, a predefined time interval, predefined time pattern or a trigger is in each case used to insert one of the security-protected items of time information in the form in each case of one of the transactions in a respective one of the blocks into the blockchain or into the distributed database.

The method is advantageous in particular for providing time information within a predefined interval, providing it at the predefined times of a time pattern or using a trigger (for example a specific request by a computer or a node). The trigger itself may be triggered for example by booting a computer that wishes to synchronize its internal clock during a booting procedure. For this purpose, it may provide the trigger for example to the timer by way of a transaction via the blockchain or via another communication channel. If the trigger or the corresponding transaction is in particular validated successfully, the timer provides for example time information by way of the method according to embodiments of the invention.

In a further embodiment of the method, the blocks are transferred/transmitted to at least one computer or retrieved by a computer.

The method is advantageous in particular for providing security-protected time information to a computer (for example a node or a computer outside a blockchain). The retrieval/transmission may take place for example in a connection-based manner (for example TCP/IP-based), without a connection (for example UDP-based) or in a broadcast/multicast-based manner.

In a further embodiment of the method, the at least one computer synchronizes its local time information or local clock on the basis of security-protected time information from the blockchain or from the distributed database.

The method is advantageous in particular for synchronizing the internal clock of the computer by way of security-protected time information.

In a further embodiment of the method, the security-protected time information is provided by one or more timers.

The method is advantageous in particular for providing the security-protected time information by way of a node, which is for example trusted. If in particular a plurality of timers are provided, then increased reliability may be achieved for example due to redundancy of the timers.

According to a further aspect, embodiments of the invention relates to a method for synchronizing a clock of a computer, having the method steps:
receiving or retrieving at least one security-protected item of time information as claimed in one of claims 1-11 (the method according to embodiments of the invention for the computer-assisted provision of security-protected time information or one of its embodiments), wherein the block of a blockchain or of a distributed database comprises a transaction that has the security-protected time information;
setting the clock on the basis of the security-protected time information.

The method is advantageous in particular for using a computer, for example a node (for example a blockchain-based time server/timer) of the blockchain or a computer (for example client, server, time server) outside the blockchain by computers or clients.

According to a further aspect, embodiments of the invention relates to a timer for the computer-assisted provision of security-protected time information, having:
one or more time sources;
a detection module for detecting first time information from the one or more time sources;
a memory module for storing transactions, wherein
   the transactions comprise the first time information and/or
   first checksums for the first time information are calculated and the transactions comprise the first checksums;
a creation module for creating the security-protected time information by generating blocks of a blockchain or of a distributed database, wherein
   the blocks each comprise at least one of the transactions,
   the blocks are chained to one another to form the blockchain or to form the distributed database,
   a first duration is in particular determined that indicates the delay with which the security-protected time information is inserted into the blockchain or the distributed database, wherein at least some of the transactions or additional transactions each comprise the first duration as fifth additional information;
   an optional transmission module for transmitting security-protected time information.

In a further embodiment of the timer, the timer comprises a transmission module for transmitting security-protected time information.

The method is advantageous in particular for transmitting the security-protected time information to nodes or computers outside the blockchain or retrieving the security-protected time information from a timer or node. The transmission may take place for example in a connection-based manner (for example TCP/IP-based), without a connection (for example UDP-based) or in a broadcast/multicast-based manner.

In a further embodiment of the timer, the timer comprises at least one further module or a plurality of further modules for performing the method according to embodiments of the invention (or one of its embodiments) for the computer-assisted provision of security-protected time information.

According to a further aspect, embodiments of the invention relates to a device for synchronizing a clock of a node, having:
a communication module for receiving or retrieving at least one security-protected item of time information as claimed in one of claims 1-11 (the method according to embodiments of the invention for the computer-assisted provision of security-protected time information or one of its embodiments), wherein the block of a blockchain or of a distributed database comprises a transaction that has the security-protected time information;
a configuration module for setting the clock on the basis of the security-protected time information.

In a further embodiment of the device, the device comprises at least one further module or a plurality of further modules for performing the method according to embodiments of the invention (or one of its embodiments) for the computer-assisted synchronization of a clock of a node.

Also claimed is a computer program product (non-transitory computer readable storage medium having instructions, which when executed by a processor, perform actions) containing program commands for performing the method according to embodiments of the invention, wherein in each case one of the methods according to embodiments of the invention, all of the methods according to embodiments of the invention or a combination of the methods according to embodiments of the invention is able to be performed by way of the computer program product.

Additionally claimed is a variant of the computer program product containing program commands for configuring a creation device, for example a 3D printer, a computer system or a production machine suitable for creating processors and/or devices, wherein the creation device is configured with the program commands such that the device according to embodiments of the invention and/or the timer are created.

Furthermore, claimed is a provision device for storing and/or providing the computer program product. The provision device is for example a data carrier that stores and/or provides the computer program product. As an alternative and/or in addition, the provision device is for example a network service, a computer system, a server system, in particular a distributed computer system, a cloud-based computer system and/or virtual computer system that stores and/or provides the computer program product, in the form of a data flow.

This provision takes place for example as a download in the form of a program data block and/or command data block, as a file, in particular as a download file, or as a data flow, in particular as a download data flow, of the complete computer program product. This provision may also however for example take place as a partial download that consists of a plurality of portions and is in particular downloaded over a peer-to-peer network or provided as a data flow. Such a computer program product is read into a system for example using the provision device in the form of the data carrier and executes the program commands so that the method according to embodiments of the invention is executed on a computer or configures the creation device such that it creates the device according to embodiments of the invention and/or the timer.

### BRIEF DESCRIPTION

Some of the embodiments will be described in detail, with references to the following Figures, wherein like designations denote like members, wherein:

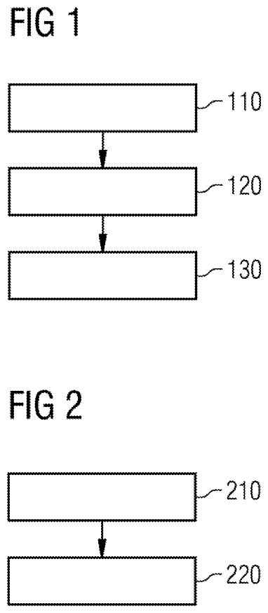

FIG. 1 shows a first exemplary embodiment of the invention in the form of a flowchart;

FIG. 2 shows a second exemplary embodiment of the invention in the form of a flowchart;

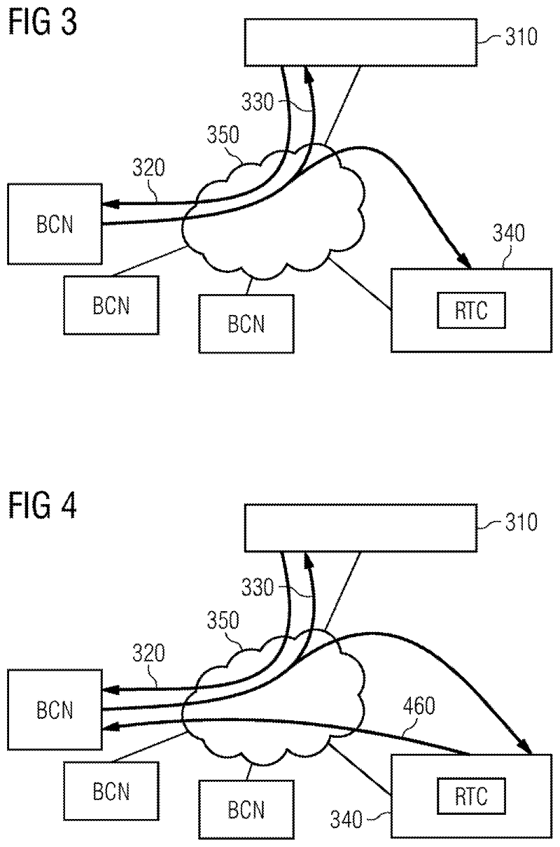

FIG. 3 shows a third exemplary embodiment of the invention;

FIG. 4 shows a fourth exemplary embodiment of the invention;

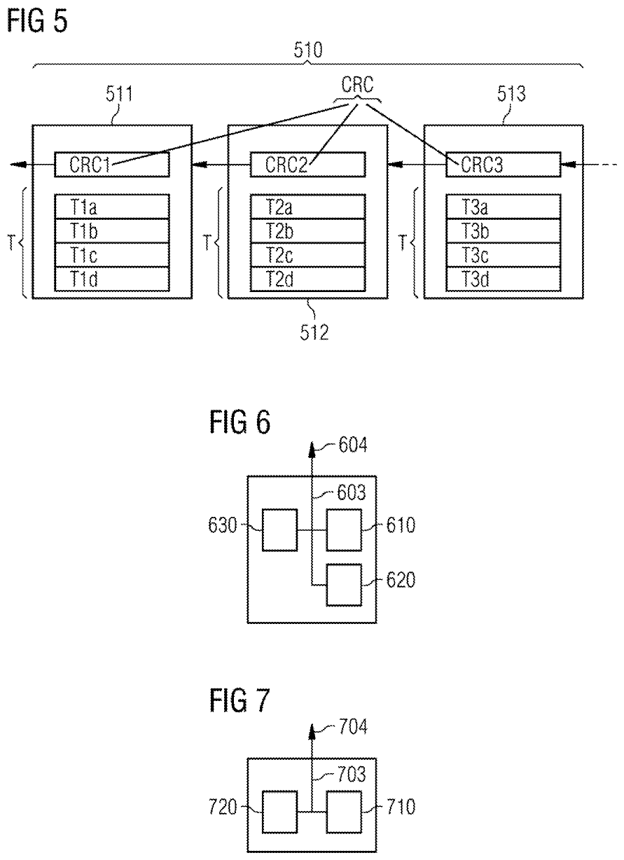

FIG. 5 shows a fifth exemplary embodiment of the invention;

FIG. 6 shows a sixth exemplary embodiment of the invention in the form of a timer; and

FIG. 7 shows a seventh exemplary embodiment of the invention in the form of a device.

### DETAILED DESCRIPTION

Functionally identical elements are provided with the same reference signs in the figures, unless indicated otherwise. The following exemplary embodiments, unless indicated otherwise or already indicated, have at least one processor and/or one memory unit for implementing or executing the method.

A (relevant) person skilled in the art having knowledge of the method claim/method claims is in particular also of course aware of all of the usual options from the prior art for creating products or implementation possibilities, such that there is no need in particular for an independent disclosure in the description. In particular, these conventional implementation variants that are known to a person skilled in the art may be implemented exclusively by way of hardware (components) or exclusively by way of software (components). As an alternative and/or in addition, a person skilled in the art, within the framework of his or her expert knowledge, may select an extremely wide variety of any desired combinations according to embodiments of the invention of hardware (components) and software (components) in order to create implementation variants according to embodiments of the invention.

A combination according to embodiments of the invention of hardware (components) and software (components) may in particular be considered when some of the effects according to embodiments of the invention are brought about exclusively by special hardware (for example a processor in the form of an ASIC or FPGA) and/or some others are brought about by the (processor-assisted and/or memory-assisted) software.

With regard to the high number of different implementation possibilities, it is in particular impossible and also not expedient or necessary for the understanding of embodiments of the invention to cite all of these implementation possibilities. In this respect, in particular all of the following exemplary embodiments are intended to show, merely by way of example, a few ways of how such implementations of the teaching according to embodiments of the invention could in particular appear.

Therefore, in particular the features of the individual exemplary embodiments are not restricted to the respective exemplary embodiment, but rather relate in particular to embodiments of the invention in general. Accordingly, features of one exemplary embodiment may also serve as features for another exemplary embodiment, in particular without this having to be mentioned explicitly in the respective exemplary embodiment.

FIG. 1 shows a first exemplary embodiment of the invention in the form of a flowchart of the method according to embodiments of the invention for the computer-assisted provision of security-protected time information.

The method is implemented in a computer-assisted manner.

Specifically, in this exemplary embodiment, a method for the computer-assisted provision of security-protected time information is performed.

The method comprises a first method step for detecting 110 first time information from one or more time sources. Here, for example, a timer that performs the method may query its local time source (for example temperature-compensated quartz oscillator, chip-scale atomic clock CSAC, regular atomic clock).

The method comprises a second method step for storing 120 transactions. The transactions in this case comprise the first time information, this being able to be implemented in various ways. It is conceivable for in each case one of the transactions to comprise one or more of the items of time information that is to say to be stored in the corresponding transaction. As an alternative, the transactions may comprise first checksums that have been calculated for the first time information. In this variant, one of the transactions comprises one or more first checksums that have each been calculated for time information. In addition to the first checksum, the transactions may comprise for example information (for example an Internet address or a memory location of a data carrier) about from where a computer or a node is able to retrieve the corresponding time information. It is also conceivable for example for this information to be disclosed generally to computers and nodes (for example by way of a computer configuration or user profiles).

The method comprises a third method step for creating 130 the security-protected time information by generating blocks of a blockchain, wherein the blocks each comprise at least one of the transactions and the blocks are chained to one another to form the blockchain.

By way of this, the timer is able for example to insert the transactions containing the time information into the blockchain or chain the corresponding blocks containing the transaction/transactions to at least one block of the blockchain.

FIG. 2 shows a first exemplary embodiment of the invention in the form of a flowchart of the method according to embodiments of the invention for synchronizing a clock of a computer.

The method is implemented in a computer-assisted manner.

Specifically, the method comprises a first method step for receiving 210 or retrieving at least one security-protected item of time information according to embodiments of the invention, as has been explained in the claims and in the embodiments of the method for the provision of the security-protected time information (for example exemplary embodiment from FIG. 1). The computer accordingly receives or the computer accordingly retrieves this information from a blockchain, wherein the block of a blockchain in particular comprises a transaction that has the security-protected time information.

In a second method step 220, the clock of the computer is set on the basis of the security-protected time information.

In other words, in particular in FIG. 1 and FIG. 2, a trusted blockchain-based time source is proposed that provides time information in a blockchain in the form of a blockchain transaction. According to embodiments of the invention create a possibility of using a decentralized blockchain in order to provide reliable/trusted time information. This may be used in particular equally within the blockchain by smart contracts and outside the blockchain.

In one variant, one or more time sources are used (for example GPS, Galileo, Glonass, Beidou, DCF77, atomic clock) and a transaction is set into the blockchain depending on the current time information (for example first time information). It is thereby in particular possible to create a timer or a primary timer (also called “blockchain master clock”) that in particular creates a master clock. The time information is then provided via a blockchain. As a result, the information is available in a decentralized manner. The primary timer provides additional information about the time sources that are used as part of the corresponding transactions or as additional transactions.

This additional information may in particular relate to or indicate the one or more time sources used (for example GPS, Galileo Open Service, Galileo PRS Service), the technical implementation of the local time source used (for example temperature-compensated quartz oscillator, chip-scale atomic clock CSAC, regular atomic clock), accuracy information (for example absolute, for example +/−1 second, drift accuracy, for example 0.01 s/24 h).

The time system may for example also be indicated (for example UTC, GPS System Time, Galileo System Time).

The primary timer furthermore checks the delay after which a block is contained in the blockchain that comprises one of the transactions (for example a real-time assertion transaction or a (real-)time assertion transaction). Depending on the determined delay, additional information is provided (for example average value/expected value of the delay, variance of the delay).

A client/computer synchronizes its local time information (for example local real-time clock, local clock) using the security-protected time information from a blockchain.

In a further variant, for this purpose, it sets a dedicated transaction into the blockchain for which it stores its local time information (or has stored it in the transaction). If this transaction of the client arises in a confirmed block of the blockchain, wherein this block comprises a transaction (which may contain security-protected time information) of the primary timer, then the client determines corresponding time offset information or a delay depending on its own buffer-stored time information and the security-protected time information of the transaction of the primary timer. Depending on this, it is in particular able to reset its local time information or its local timer (for example real-time clock, clock) (for example setting to be faster or slower) or identify the local time information as invalid (in the event of an excessively large deviation).

FIG. 3 shows a third exemplary embodiment of the invention, which implements for example a method as explained in FIG. 1 and FIG. 2.

Specifically, FIG. 3 shows an exemplary system containing a plurality of nodes BCN of the blockchain that form a blockchain (for example Bitcoin nodes or Ethereum nodes). The arrows represent possible information flows. Since the blockchain is a decentralized distributed database, it is possible to communicate with one of the multiplicity of identical nodes of the blockchain (or blockchain nodes for short) via a network 350 (for example a LAN, WAN or the Internet). A (primary) timer 310 according to embodiments of the invention (for example also called blockchain real-time oracle), which in particular performs the method according to embodiments of the invention for the provision of security-protected time information (explained for example in FIG. 1), sets time information into the blockchain by way of a transaction (for example a real-time confirmation transaction or a time synchronization transaction) 320 containing time confirmation information, in particular in order to confirm the time information. This is performed repeatedly, in particular periodically.

This comprises additional information to the actual time information. A plurality of blocks of the blockchain are provided for this purpose. A particular node 340 (also RTC node) may use the real-time confirmation transaction(s) 330 contained in a blockchain in order to adjust its local real-time clock (RTC). For this purpose, configuration parameters of the real-time clock are adjusted (current time information, drift speed correction parameter).

FIG. 4 shows a fourth exemplary embodiment of the invention that implements for example a method as explained in FIG. 1 and FIG. 2, or a variant to the exemplary embodiment of FIG. 3.

The exemplary embodiment differs from the exemplary embodiment from FIG. 3 in that the particular node 340 (also called RTC node) that wishes to synchronize its real-time clock inserts security-protected time information (for example in one of the transactions in the form of a time synchronization transaction (TimeSync transaction)) 460 into the blockchain. This may comprise for example a nonce value (for example a cryptographic nonce), a counter value, a random value or the value of the real-time clock. The RTC node 340 furthermore locally stores its local real-time clock time information (for example the time and/or the type of real-time clock) and/or additional information at this time. The RTC node then waits until its synchronization transaction 460 is contained in a confirmed block of the blockchain.

It furthermore determines the time information of the real-time confirmation transaction of the (primary) timer that is comprised/contained in the same block.

In one variant, the time information in a neighboring block or in neighboring blocks is taken into consideration, wherein for example at most a predefined number to the neighboring block (for example at most the fifth neighboring block is (individually) taken into consideration) or of the neighboring blocks (for example at most the fifth neighboring block (on average) is taken into consideration) is taken into consideration. In other words, for example, a maximum permissible block distance is defined up to which neighboring block/blocks are taken into consideration. The neighboring blocks are in particular successfully validated or confirmed blocks of the blockchain.

The RTC node 340 then determines the difference between its local real-time information (buffer-stored or contained in the TimeSync transaction) and that of the real-time confirmation transaction. Depending on this, configuration parameters (for example configuration parameters of the real-time clock) are updated (for example the real-time clock is moved forward or backward, or the drift speed correction is increased or reduced).

FIG. 5 shows a fifth exemplary embodiment of the invention in the form of a blockchain that is suitable for implementing the above exemplary embodiments.

Specifically, FIG. 5 shows the blocks 510, for example a first block 511, a second block 512 and a third block 513, of a blockchain.

The blocks 510 each comprise a plurality of transactions T. The first block 511 comprises for example a first transaction T1a, a second transaction T1b, a third transaction T1c and a fourth transaction T1d. The second block 512 comprises for example a fifth transaction T2a, a sixth transaction T2b, a seventh transaction T2c and an eighth transaction T2d. The third block 513 comprises for example a ninth transaction T3a, a tenth transaction T3b, an eleventh transaction T3c and a twelfth transaction T3d.

The blocks 510 in each case additionally comprise another chaining checksum CRC that is formed depending on the directly preceding block. The first block 511 thus comprises a first chaining checksum CRC1 from its predecessor block, the second block 512 comprises a second chaining checksum CRC2 from the first block 511, and the third block 513 comprises a third chaining checksum CRC3 from the second block 512. The chaining checksum may beformed by the block header of the corresponding predecessor block. The chaining checksum CRC may be formed using a cryptographic hash function such as for example SHA-256, KECCAK-256 or SHA-3.

In addition, each of the blocks may comprise a transaction checksum. This may be formed by way of a hash tree.

To form the hash tree, a third/further checksum (for example likewise a hash value that is formed depending on the transactions/transaction datasets) is calculated for each transaction of a block.

A hash tree, for example a Merkle tree or a Patricia tree, whose root hash value/root checksum may be stored as a transaction checksum in the respective block, is usually used.

In one variant, the transaction checksum is used as a chaining checksum.

A block may furthermore have a timestamp, a digital signature, proof of work, as has been explained in the embodiments of the invention. In other words, FIG. 5 shows a blockchain that is suitable in particular for implementing the method according to embodiments of the invention. A block (for example a data structure) comprises at least one hash value (for example the chaining checksum) that is formed depending on the predecessor block. A block furthermore comprises information about a plurality of transactions (for example likewise a hash value (for example a transaction checksum) that is formed depending on the transactions).

A transaction may contain a program code in the form of a smart contract. The program code in particular indicates which transactions are permissible. As a result, it is possible to perform various business procedures by way of a common blockchain or blockchain infrastructure (a system having a plurality of nodes as in FIG. 3 or FIG. 4) in a flexible manner. By way of example, a hash tree, for example a Merkle tree or Patricia tree, whose root hash value is stored in a block, is used for the transaction checksum of a block. A block may furthermore have for example a timestamp, a digital signature, proof of work (proof of work is the solution to a computationally intensive task that needs to be solved depending on the block content; such a computationally intensive task is also referred to as a cryptographic puzzle).

To improve understanding of embodiments of the invention, one possible use of the blockchain illustrated in FIG. 5 together with embodiments of the invention is now explained in more detail. Only one exemplary implementation of the blockchain is explained, and the data that are specifically used in this explanation serve only for the purposes of understanding and should not be understood as restricting embodiments of the invention.

Specifically, the first transaction T1a is a payment transaction, as is known for example for Bitcoin.

The second transaction T1b is a transaction for transferring ownership rights, as is known for example for Bitcoin.

The third transaction T1c is a real-time confirmation transaction (as explained for example in FIG. 3) of the (primary) timer. The third transaction Tic comprises first time information (for example 20170111143107 for 1.11.2017, 14:31:07) and additional information about the time system (for example UTC, that is to say the GPS time has already been converted into UTC time), a variance of the time information (for example 17 seconds), the type of time source (for example GPS) and a node checksum of the (primary) timer (for example a digital signature).

The fifth transaction T2a is a payment transaction, as is known for example for Bitcoin.

The sixth transaction T2b is a time synchronization transaction (TimeSync transaction) of the RTC node (see exemplary embodiments above). The sixth transaction T2b comprises a first value of the real-time clock of the RTC node (for example 20170111143417) and a node checksum (for example a digital signature of an RTC node as in FIG. 4).

The seventh transaction T2c is a further time synchronization transaction (TimeSync transaction) of the RTC node. The seventh transaction T2c comprises a nonce value (for example a cryptographic nonce) based on a random value and a node checksum (for example a digital signature of an RTC node as in FIG. 4).

The ninth transaction T3a is a further time synchronization transaction (TimeSync transaction) of the RTC node (for example an RTC node as in FIG. 4). This comprises a nonce value (for example a cryptographic nonce based on a random value), a counter value, a random value, a second value of the real-time clock of the RTC node (for example 20170111143718) and a node checksum (for example a digital signature of an RTC node as in FIG. 4).

The tenth transaction T3b is a further real-time confirmation transaction (as explained for example in FIG. 3) of the (primary) timer. The tenth transaction T3b comprises second time information (for example 20170111143739) and state information about the time system (for example UTC), a variance of the time information (for example 17 seconds), the type of time source (for example GPS) and a node checksum of the (primary) timer (for example a digital signature).

The remaining transactions from FIG. 5 are not important for further consideration and are not explained in more detail.

Specifically, the blockchain now comprises a plurality of blocks containing different transactions of different nodes. A block contains a plurality of transactions, for example including about payment procedures or about the change of assignment of the owner of an object.

According to embodiments of the invention, at least one real-time confirmation transaction ((real-)time assertion transaction), such as for example the third transaction T1c, is contained. The real-time confirmation transactions may also comprise further additional information, such as for example an identifier (SVID, space vehicle ID) of the received GPS satellites used for the time determination/time source, a respective received signal strength, a used frequency band (for example L1, L2, L5), a used code (for example P(Y)-code or M-code), detected reflections or jammers. In the case of using the Galileo satellite navigation system for time determination, the Galileo service that is used, for example open service, commercial service or PRS service, could also for example be indicated.

In particular, security-protected time information in the form of time synchronization transactions are thus contained in the transactions T, for example present in the ninth transaction T3a, the sixth transaction T2b or the seventh transaction T2c. These may also in each case for example contain local time information and/or a nonce (for example a random value).

The third block 513 therefore comprises both a time synchronization transaction and a real-time confirmation transaction.

The RTC node that set/inserted the time synchronization transaction may determine the time difference/delay (for example as first duration) between the time information, attested in this block, of the tenth transaction T3b (for example 20170111143718) of the primary timer and the first value of the real-time clock of the RTC node (for example 20170111143739) of the ninth transaction T3a. In this example, the local clock of the RTC node is running in particular 21 seconds later than the primary timer or the tenth transaction T3b of the primary timer. Depending on the delay, and possibly on further parameters such as the confirmed variance of the tenth transaction T3b, the corresponding RTC node may for example adjust a configuration parameter of its local real-time clock.

If the RTC node has set a time synchronization transaction (containing security-protected time information) but this is inserted into a block of the blockchain that does not contain any real-time confirmation transaction (for example the second block 512), then the node in question may estimate a time for this block for example depending on the confirmed time information of previous and/or subsequent blocks. In this example, the second block 512 could for example determine 20170111143423 as estimated value by using an average value between the confirmed time information of the predecessor block 14:31:07 (first block 511 and the time information of the third transaction T1c) and of the following block 14:37:39 (third block 513, tenth transaction T3b). Using these two values, the RTC node is able to determine a time difference of 00:06:32. The RTC node is then able to use these values to determine an estimated value for time information for the second block 512 or for the sixth and seventh transaction: 14:31:07+00:06:32/2=14:31:07+00:03:16=14:34:23.

The blockchain may, in particular, comprise for example a multiplicity of blocks, each of which comprises just one portion or a single transaction containing security-protected time information, such as for example a time synchronization transaction, (real-)time confirmation transaction ((real-)time information confirmed by the blockchain) or time synchronization transaction.

In particular, using the time confirmation transactions or security-protected time information contained in at least some or all of the blocks, it is possibly also possible to estimate a later time, at which time any desired transaction of a block (for example change of ownership, payment procedure) has taken place.

FIG. 6 shows a sixth exemplary embodiment of the invention in the form of a (primary) timer for the computer-assisted provision of security-protected time information.

The timer comprises one or more time sources, a detection module 610, a memory module 620, a creation module 630 and an optional first communication interface 604, these being connected to one another in terms of communication by a first bus 603.

The timer may for example additionally comprise yet another or a plurality of further components, such as for example a processor, a memory unit, an input device, in particular a computer keypad or a computer mouse, and a display device (for example a monitor). The processor may comprise for example a plurality of further processors, wherein the further processors for example each implement one or more of the modules. As an alternative, the processor in particular implements all of the modules of the exemplary embodiment. The further component/components may likewise for example be connected to one another in terms of communication by the first bus 603.

The processor may be for example an ASIC that has been implemented in an application-specific manner for the functions of a respective module or all of the modules of the exemplary embodiment (and/or further exemplary embodiments), wherein the program components or the program commands are implemented in particular as integrated circuits. The processor may also be for example an FPGA that is configured by way of the program commands in particular such that the FPGA implements the functions of a respective module or all of the modules of the exemplary embodiment (and/or further exemplary embodiments).

The detection module 610 is configured so as to detect first time information from the one or more time sources.

The detection module 610 may be implemented or formed for example by way of the processor, the memory unit and a first program component, wherein for example the processor is configured, by executing program commands of the first program component or the processor is configured, by the program commands, such that the first time information is detected.

The memory module 620 is configured so as to store transactions, wherein
the transactions comprise the first time information and/or
first checksums for the first time information are calculated and the transactions comprise the first checksums.

The memory module 620 may be implemented or formed for example by way of the processor, the memory unit and a second program component, wherein for example the processor is configured, by executing program commands of the second program component or the processor is configured, by the program commands, such that the transactions are stored.

The creation module 630 is configured so as to create the security-protected time information by generating blocks of a blockchain, wherein the blocks each comprise at least one of the transactions and the blocks are chained to one another to form the blockchain.

The creation module 630 may be implemented or formed for example by way of the processor, the memory unit and a third program component, wherein for example the processor is configured, by executing program commands of the third program component or the processor is configured, by the program commands, such that the security-protected time information is created.

The program commands of the respective modules may in this case be executed for example by way of the processor itself and/or by way of a boot component, for example a loader or a configuration component.

FIG. 7 shows a seventh exemplary embodiment of the invention in the form of a device for the computer-assisted synchronization of a clock of a computer.

The device comprises a communication module 710, a configuration module 720, and an optional second communication interface 704, these being connected to one another in terms of communication by a second bus 703.

The timer may for example additionally comprise yet another or a plurality of further components, such as for example a processor, a memory unit, an input device, in particular a computer keypad or a computer mouse, and a display device (for example a monitor). The processor may comprise for example a plurality of further processors, wherein the further processors for example each implement one or more of the modules. As an alternative, the processor in particular implements all of the modules of the exemplary embodiment. The further component/components may likewise for example be connected to one another in terms of communication by the second bus 703.

The processor may be for example an ASIC that has been implemented in an application-specific manner for the functions of a respective module or all of the modules of the exemplary embodiment (and/or further exemplary embodiments), wherein the program components or the program commands are implemented in particular as integrated circuits. The processor may also be for example an FPGA that is configured by way of the program commands in particular such that the FPGA implements the functions of a respective module or all of the modules of the exemplary embodiment (and/or further exemplary embodiments).

The communication module 710 is configured so as to receive or retrieve at least one security-protected item of time information according to embodiments of the invention (or security-protected time information created by the corresponding method according to embodiments of the invention), wherein the block of a blockchain comprises a transaction that has the security-protected time information.

The communication module 710 may be implemented or formed for example by way of the processor, the memory unit and a first program component, wherein for example the processor is configured, by executing program commands of the first program component or the processor is configured, by the program commands, such that the security-protected time information is received or retrieved.

The configuration module 720 is configured so as to set the clock on the basis of the security-protected time information.

The configuration module 720 may be implemented or formed for example by way of the processor, the memory unit and a second program component, wherein for example the processor is configured, by executing program commands of the second program component or the processor is configured, by the program commands, such that the clock is set.

The program commands of the respective modules may in this case be executed for example by way of the processor itself and/or by way of a boot component, for example a loader or a configuration component.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for the computer-assisted transmission of security-protected time information, having the following method steps:
recording first time information from one or more time sources;
storing transactions, wherein
the transactions comprise the first time information and
first checksums for the first time information are calculated and the transactions comprise the first checksums;
creating the security-protected time information by generating blocks of a blockchain or of a distributed database, wherein
the blocks each comprise at least one of the transactions,
the blocks are chained to one another to form the blockchain or to form the distributed database,
a first duration is determined that indicates the delay with which the security-protected time information is inserted into the blockchain or the distributed database, wherein at least some of the transactions or additional transactions each comprise the first duration as fifth additional information;
transmitting the blocks to at least one computer.

2. The method as claimed in claim 1, wherein the blocks are chained to one another by a cryptographic hash function.

3. The method as claimed in claim 1, wherein the one or more time sources is/are a GPS time source and/or a Galileo time source and/or Glonass time source and/or Beidou time source and/or DCF77 time source and/or atomic clock time source and wherein at least some of the transactions or additional transactions comprise first additional information about the time source.

4. The method as claimed in claim 1, wherein at least some of the transactions or additional transactions each comprise second additional information that indicates a type of the time source.

5. The method as claimed in claim 1, wherein at least some of the transactions or additional transactions each comprise third additional information that indicates an accuracy of the security-protected time information.

6. The method as claimed in claim 1, wherein at least some of the transactions or additional transactions each comprise fourth additional information that indicates a time system of the security-protected time information.

7. The method as claimed in claim 1, wherein
the transactions of at least some of the blocks comprise at least the first time information and the first duration.

8. The method as claimed in claim 1, wherein if a particular block of the blockchain or of the distributed database comprises a transaction containing first time information and the particular block does not comprise any transaction containing the first duration, a corresponding first duration for the particular block is interpolated and/or approximated from one or more blocks preceding the particular block and/or one or more blocks following the particular block.

9. The method as claimed in claim 1, wherein a predefined time interval, a predefined time pattern or a trigger is in each case used to insert one of the security-protected items of time information in the form in each case of one of the transactions in a respective one of the blocks into the blockchain or into the distributed database.

10. The method as claimed in claim 1, wherein the at least one computer synchronizes its local time information on the basis of security-protected time information from the blockchain or from the distributed database.

11. The method as claimed in claim 1, wherein the security-protected time information is provided by one or more timers.

12. A method for synchronizing a clock of a computer, having the method steps:
receiving at least one security-protected item of time information as claimed in claim 1, wherein the block of a blockchain or of a distributed database comprises a transaction that has the security-protected time information;
setting the clock on the basis of the security-protected time information.

13. The method as claimed in claim 12, wherein a first duration of a transaction is additionally taken into consideration when setting the clock.

14. A timer for the computer-assisted transmission of security-protected time information, having:
one or more time sources;
a detection module for detecting first time information from the one or more time sources;
a memory module for storing transactions, wherein
the transactions comprise the first time information and/or
first checksums for the first time information are calculated and the transactions comprise the first checksums;
a creation module for creating the security-protected time information by generating blocks of a blockchain or of a distributed database, wherein
the blocks each comprise at least one of the transactions,
the blocks are chained to one another to form the blockchain or to form the distributed database,
a first duration is determined that indicates the delay with which the security-protected time information is inserted into the blockchain or the distributed database, wherein at least some of the transactions or additional transactions each comprise the first duration as fifth additional information;
a transmission module for transmitting security-protected time information.

15. A device for synchronizing a clock of a computer, having:
a communication module for receiving at least one security-protected item of time information as claimed in claim 1, wherein the block of a blockchain or of a distributed database comprises a transaction that has the security-protected time information;
a configuration module for setting the clock on the basis of the security-protected lime information.

16. A computer program product, comprising a computer readable hardware storage device having computer readable program code stored therein, said program code executable by a processor of a computer system to implement a method containing program commands for performing the methods as claimed in claim 1.

17. A computer program product containing program commands for a creation device that is configured by way of the program commands so as to create the timer as claimed in claim 14.

18. A provision device for the computer program product as claimed in claim 16, wherein the provision device stores and or prov ides the computer program product.
